(19) United States
(12) Patent Application Publication
(10) Pub. No.: US 2007/0068404 A1
(43) Pub. Date: Mar. 29, 2007

(54) Systems and methods for additive deposition of materials onto a substrate

(76) Inventors: Edwin Hirahara, Federal Way, WA (US); David L. Lee, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/238,408

(22) Filed: Sep. 29, 2005

(51) Int. Cl. B41F 5/00; B41F 7/00; B41J 2/01

(52) U.S. Cl. 101/141; 347/103

(57) ABSTRACT

A two stage printing process that includes a digital first stage in the form of a non-contact material metering device, such as one or more digital inkjet heads, for selectively discharging a metered quantity of material, and an analog second stage, such as flexographic print and impression cylinders, for transferring the material deposited thereon by the non-contact material metering device onto a substrate.

### FIELD OF THE INVENTION

Embodiments of the present invention relate generally to printing systems, and more particularly, to printing systems and methods for depositing one or more layers of material in an additive process.

### BACKGROUND OF THE INVENTION

Electrically conducting and semiconducting organic polymers have become available in recent years. Along with conventional insulating polymers, conducting and semiconducting organic polymers enable the construction of micro-electronic components or complete circuits on flexible substrates using polymers. Some examples of micro-electric components that may be produced include capacitors, resistors, diodes, and transistors, while examples of complete circuits may include RFID tags, sensors, flexible displays, etc.

Currently, these polymer electronic components and circuits are fabricated by well known subtractive processes in which polymer deposition onto the substrate is followed by removal, i.e., by etching, of unwanted materials. This well known process is slow, complex, expensive and impractical for producing low-cost electronic devices. Thus, there is a need in the electronics fabrication industry for a fully additive process to fabricate polymeric and non-polymeric electronic components. However, no suitable fully additive process for printing electronics is currently known in the art.

In general, printing is an additive process where images are printed layer by layer to form the printed image. As generally known, graphic images are classified into two basic categories, vector images and raster images. Raster images are typically characterized as natural images or photographs. Raster images are characterized by continuous tones and a broad range of spatial frequencies, where image encoding must be achieved pixel by pixel. On the other hand, vector images are composed of primarily text, lines, solids and fields. The image is quite simple and may be reduced into mathematical formulas describing the location, size, shape, and color of the object to be rendered. With vector images, no continuous tones need to be produced using halftone screening techniques. As such, it will be appreciated that printing electronics is more analogous to printing vector images, and thus, print technologies that can print vector images are believed to be the most promising printing platform for printing electronics.

While conventional printing techniques are capable of reproducing both vector and raster images, they cannot easily meet many of the stringent design requirements of printed electronics, including, for example, (a) the ability to deposit very precise amounts of material onto a substrate; (b) the ability to render very thin lines and spacings on the order of, for example, approximately three (3) microns; (c) the ability to transfer extremely uniform and ultra thin layers of material on the order of, for example, approximately 50-100 nanometers; (d) the ability to achieve print registration within, for example, approximately 25 microns from layer to layer; and (e) the ability to render sharp and continuous edges.

The first category of printing techniques that will be discussed are the analog printing presses, sometimes referred to as contact-type printing presses for their technique of utilizing physical contact between the print cylinder and the substrate to transfer ink therebetween. Some examples of these include flexography, gravure, letterpress, screen, and lithography, a few of which will be briefly described in detail with reference to FIGS. 10-12.

Turning now to FIG. 10, there is shown one example of a conventional flexographic printing system, general designated 320. As best shown in FIG. 10, the conventional flexographic printing system 320 includes a flexographic print cylinder 324 carrying a printing plate 326, and an impression cylinder 328 opposing the print cylinder 324 to form a printing nip 330 through which a substrate web 334 is routed. The conventional flexographic printing system 320 also includes an ink-metering roller 340 that transfers a metered quantity of ink to the print cylinder 324. The printing plate 326 includes relief areas that form the desired print image 344. In use, the printing plate 326 of the print cylinder transfers ink applied thereto by contact with the ink metering roll 340 to the substrate web 334 that passes through the printing nip 330, thereby forming the printing image 346. As the substrate web 334 travels through the printing nip 330, the impression cylinder 328 backs up and supports the substrate web 334 as the substrate web 334 contacts the print cylinder 324.

The ink metering roll 340, also called an anilox roll, has a surface that is engraved with tiny uniform cells or pockets (not shown) that carry and deposit an ink film onto the printing plate. In some flexographic presses, the ink is metered to the anilox roll by a separate fountain roll 348 that picks up the ink from an ink pan 350 and transfers it to the anilox roll 340 in a contact transfer that squeezes out excess ink. In more modern configurations, not shown, the anilox roll 340 serves the dual purpose of a fountain roll and metering roll by use of a doctor blade (not shown), which is an elongated metal blade or knife that shaves excess ink off the anilox roll, leaving only ink in the recessed cells.

In a color printing environment, the flexographic printing press 320 includes a print station for each desired ink color. For example, a four process color printing press includes four printing stations, one for the colors C, M, Y, and K. The print stations each include a separate ink pan, an optional fountain roll, an anilox roll, and a print cylinder. Each print station may also include a discrete impression cylinder 328 as shown or each print station may utilize a portion of a central impression cylinder (CIC), in a configuration well known in the art.

Turning now to FIG. 11, there is shown a conventional gravure printing press, generally designated 420. As best shown in FIG. 11, the gravure printing press 420 comprises a print cylinder 424 having a printing surface 428, an ink reservoir 430, and an impression cylinder 434. The printing surface 428 defines an image to be printed. The image area consists of honeycomb shaped cells or wells that are etched or engraved into the cylinder 424. The un-etched areas of the cylinder 424 represent the non-image or unprinted areas. The printing cylinder 424 is immersed in the ink reservoir as it is rotated. As the print cylinder 424 is rotated in the ink reservoir, it picks up ink, which fills the etched cells on the cylinder surface 428. As the cylinder 424 turns, the excess ink is wiped off the cylinder by a flexible steel doctor blade 444. The impression cylinder 434 includes a surface of, for example, rubber, nitrile, polyurethane or the like, and is mounted tangentially to the print cylinder 424. The impression cylinder 434 operates to depress the traveling substrate web 450 against the printing surface 428 as the substrate web 450 passes between the print cylinder 424 and the impression cylinder 434. The contact between the print cylinder 424 and the substrate web 450 causes the ink located in the cells to be transferred onto the substrate web 450 in the form of the printed image.

Turning now to FIG. 12, there is shown one embodiment of a conventional offset lithographic printing press, generally designated 520. Since lithography is an “offset” printing technique, ink is not applied directly from the printing plate (or cylinder) to the substrate as it is in gravure or flexography, but is applied to the printing plate to form the “image” (such as text or artwork to be printed), which is then transferred or “offset to a rubber “blanket.” The image on the blanket is then transferred to the substrate (typically paper or paperboard) to produce the printed product.

The lithographic press 520 includes three printing cylinders, the plate on cylinder 524, the blanket cylinder 528 and the impression cylinder 532, as well as an inking system 536 and a dampening system 540. Lithography uses a planographic plate 542, supported by the plate cylinder. A planographic plate is a type of plate on which the image areas are neither raised nor indented (depressed) in relation to the non-image areas. Instead the image and non-image areas, both on essentially the same plane of the printing plate, are defined by deferring physiochemical properties.

The plate on cylinder 524 undergoes chemical treatment that render the image area of the plate oleophilic (oil-loving) and therefore ink-receptive and the non-image area hydrophilic (water-loving). During printing, dampening solution, which consists primarily of water with small quantities of isopropyl alcohol and other additives to lower surface tension and control pH, is first applied in a thin layer to the printing plate by the dampening system 540. The dampening solution migrates to the hydrophilic non-image areas of the printing plate 542. Ink is then applied to the printing plate by the inking system 536. The ink migrates to the oleophilic image areas. Since the ink and water essentially do not mix, the fountain solution prevents ink from migrating to the non-image areas of the plate.

While flexographic, gravure, and lithographic printing presses of the type shown in FIGS. 10-12, as well as other analog printing presses, such as letterpress, etc., work well in traditional printing applications, such as newspaper printing, magazine printing, package printing, etc., these analog techniques suffer many drawbacks that would potentially affect both the capability of printing electronic devices and the reliability of the resulting printed electronic devices. One such drawback is the inability of some analog presses to print crisp and continuous lines and solids, which are used extensively in printed electronics. For example, gravure printing presses, due to the etched cells in the print cylinder, screen the image from the print cylinder onto the substrate. As well known in the art, half-tone screening renders images with an array of closely spaced dots that the human eye integrates to perceive the printed image. However, while screening works well for photographs, screening results in spaced dots with poor ink spread, as well as missing dots (caused by rough surfaces preventing good contact between the plate and the substrate). Spaced dots with poor ink spread and missing dots compromise continuity of the rendered layer, which may result in non-functional electronic devices.

Another drawback of analog or contact type printing presses is the inability of analog printing presses to reliably meter and uniformly transfer very thin (e.g., 5-100 nanometers) layers of ink onto a substrate due to, among others, the conventional anilox or metering roll. For example, in flexographic presses, the inherent attributes of the anilox roll (i.e., cell frequency) and the physical means of transferring ink to the print cylinder results in inaccurate and non-constant ink film thicknesses once the ink is transferred from the printing plate to the substrate. Additionally, the use of doctor blades in both flexography and gravure may cause uneven ink distribution along the print cylinders, resulting in non-uniform layers when deposited on the substrate.

Yet another drawback of analog or contact type printing presses is the inability to render very small features, such as traces, electrodes, etc. For example, an approximately one inch 13.56 MHz RFID tag would require components, such as transistors, to be rendered with approximately three (3) micron source and drain electrodes, and would require spacing between such features of approximately three (3) microns. Reliably printing three micron features is not currently attainable by conventional printing presses. For example, a nominal diameter of a 1% dot on a lithographic printing plate screened at 133 lpi (lines per inch) is about 10 microns. To reliably print three (3) micron features would require the ability to reliably print a 1% dot at screening frequencies of approximately 500 lpi, which exceed current printing capabilities.

Finally, many conventional analog presses are not able to meet the registration tolerance of approximately 25 microns called for in many printed electronic design specifications. For example, a typical commercial lithography press can achieve a registration error on the order of a row's spacing of half-tone dots. Since a commonly used screen frequency is 133 lpi, this calculates into a tolerance of approximately 94 microns. Even if registration error could be cut in half, 47 microns is still about twice the needed design tolerance for most printed electronic devices. Even with tighter control, registration could be achieved only “on average,” which means that actual registration from print to print could vary substantially thereby considerably reducing device yield.

Problems with printing electronic devices are not only limited to contact-type printing presses. Recently, digital printing techniques have been developed to augment traditional analog printing techniques for improving cost, speed, workflows, etc. However, digital printing techniques are not without their problems. One type of digital printing device, also referred to as a non-contact device since these devices deposit material onto a substrate without making contact with the substrate, is the digital inkjet. Several types of inkjets have been developed, including piezoelectric and thermal (bubble jet), which are capable of depositing precise quantities of ink onto the substrate at specific locations based on received discharge signals.

However, like gravure printing presses, inkjet printing is inherently a screening process, and thus, does not render vector images as well as raster images. Specifically, inkjet printing results in jagged edges, and inconsistent and non-continuous solids. Additionally, inkjets also tend to produce a wavy film consisting of a layer of individual ink drops, and may result in non-uniform layer thicknesses. Such problems can potentially affect printing electronic operations and reliability.

### SUMMARY OF THE INVENTION

In accordance with aspects of the present invention, a method of printing an electronic device onto a substrate is provided. The method includes obtaining a substrate, and routing the substrate through a sequential series of printing nips. The nips are formed between at least a portion of one substrate support structure and a plurality of plate structures, each plate structure defining a print image. One of a plurality of materials is sequentially deposited onto the print images of the plate structures. The sequential depositing of material is carried out by a plurality of non-contact metering devices, wherein the print image of each plate structure represents the final image layers to be printed on the substrate. The method further includes sequentially transferring the material deposited on the print images of the plate structures onto the substrate layer-by-layer as the substrate is routed through the sequential series of printing nips, thereby forming, in an additive manner, a printed electronic device comprised of a plurality of printed image layers.

In another aspect of the present invention, a method of printing a plurality of print layers is provided. The method includes routing a substrate to a first printing station, whereby the first printing station comprises a non-contact material metering device, a print cylinder defining a first print image, and at least a portion of an impression cylinder, depositing a first material onto the print image of the print cylinder by a non-contact material metering device, and transferring the first material deposited on the print image onto the substrate, thereby forming a discrete first printed image layer. The method further includes routing the substrate to a second printing station, whereby the second printing station comprises a second non-contact material metering device, a second print cylinder defining a second print image, and a portion of an impression cylinder, depositing a second material onto the second print image of the second print cylinder by the second non-contact material metering device; and transferring the second material from the second print image onto at least a portion of the first printed layer, thereby forming a discrete second printed image layer.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a functional block diagram of an exemplary embodiment of a printing system formed in accordance with aspects of the present invention;

FIG. 2 is a partial schematic view of several components of the printing system of FIG. 1;

FIG. 3A is a magnified partial view of the printing nip of the printing system of FIG. 2 prior to material transfer;

FIG. 3B is a magnified partial view of the printing nip of the printing system of FIG. 2 subsequent to material transfer;

FIG. 4 is a functional block diagram of another exemplary embodiment of a printing system formed in accordance with aspects of the present invention;

FIG. 5 is a schematic view of the printing system of FIG. 4;

FIGS. 6A-6C are partial schematic views of the first, second, and third printing stations, respectively, of the printing system of FIG. 5;

FIGS. 7A-7C are top views of one exemplary set of printing plates that may be utilized by the printing system of FIG. 5;

FIGS. 8A-8C are side views of one exemplary embodiment of a printed electronic device being fabricated layer by layer by the printing system of FIGS. 4 and 5;

FIG. 9 is another embodiment of a printing system formed in accordance with aspects of the present invention;

FIG. 10 is a schematic representation of one conventional flexographic printing press;

FIG. 11 is a schematic representation of one conventional gravure printing press; and

FIG. 12 is a schematic representation of one conventional offset lithographic printing press.

### DETAILED DESCRIPTION OF EXEMPLARY EMBODIMENTS

Embodiments of the present invention will now be described with reference to the accompanying drawings where like numerals correspond to like elements. The following description provides examples of systems and methods for fabricating printed electronic devices with polymeric and non-polymeric materials in a fully additive process. The systems and methods of the present invention may also be suitable for use in printing color graphics, or to color, coat, varnish, or apply other surface treatments to a variety of substrates. The following examples generally describe the systems and methods as a two stage printing process that includes a digital first stage in the form of a non-contact material metering device, such as one or more digital inkjet heads, vapor deposition systems, aerosol systems, etc., for selectively discharging a metered quantity of material, and an analog second stage, such as flexographic print and impression cylinders, for transferring the material deposited thereon by the non-contact material metering device onto a substrate. Since these printing systems utilize both digital and analog stages, they may also be referred to as “hybrid printing systems.” However, it should be apparent that these examples are only illustrative in nature and should not be considered as limiting the embodiments of the present invention, as claimed.

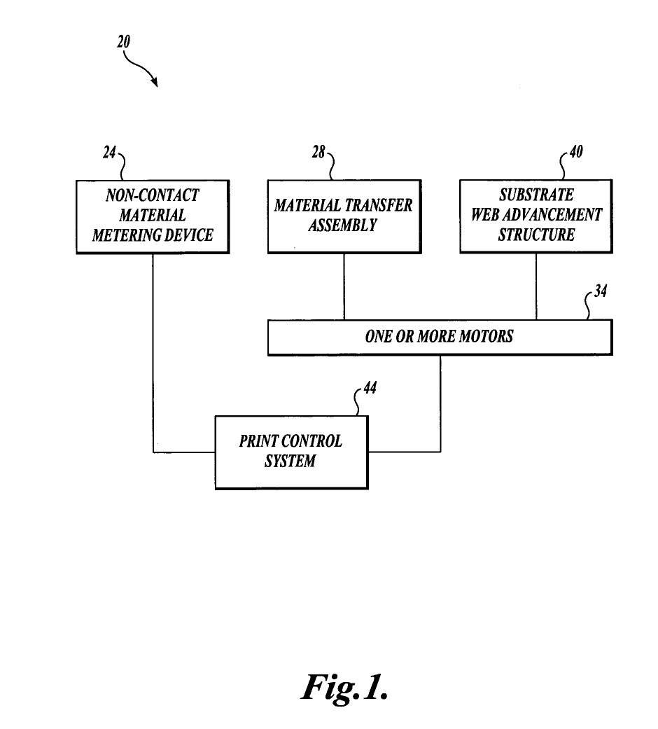

In the face of drawbacks and deficiencies in conventional printing techniques discussed above, the inventors of the present application have developed, as described in detail below, hybrid printing systems and methods for selective deposition of materials onto a substrate for fabricating, for example, printed electronics in a fully additive process. To that end, and in accordance with aspects of the present invention, one exemplary embodiment of a hybrid printing system will now be described in detail with reference to FIG. 1. Referring now to FIG. 1, there is shown a schematic diagram depicting one exemplary hybrid printing system, generally designated 20, which is formed in accordance with aspects of the present invention. Generally described, the hybrid printing system 20 includes a non-contact material metering device 24 and a material transfer assembly 28 for receiving a precisely metered quantity of material from the non-contact material metering device 24 and depositing the material in selected quantities and locations as a discrete layer onto a substrate. The printing system 20 further includes one or more drive motors 34, a substrate web advancement structure 40 and a print control system 44 for controlling the overall printing process.

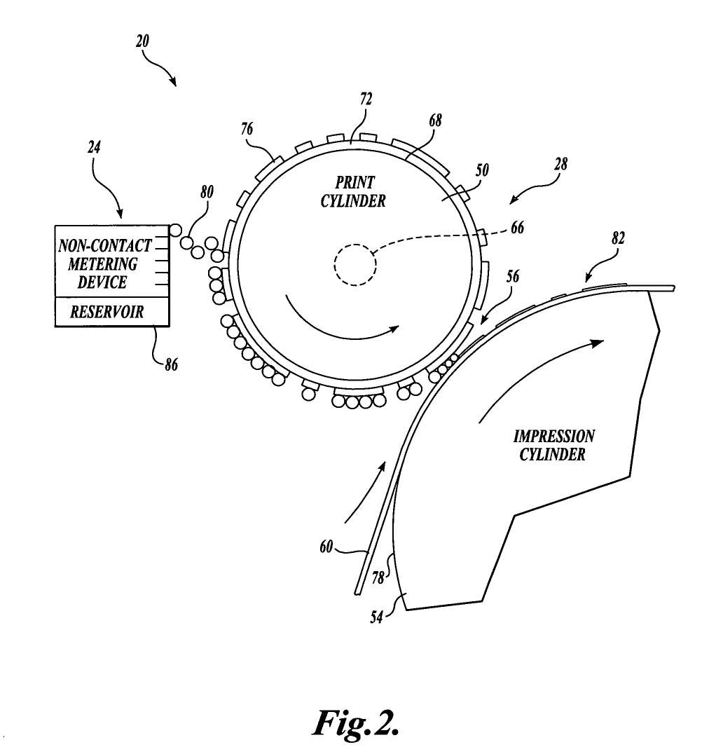

In one embodiment of the present invention, the material transfer assembly 28 may be configured like any known flexographic or similarly configured press comprised of a print cylinder, an impression cylinder, and conventional structure for advancing a substrate in-between the print cylinder and the impression cylinder. In one exemplary embodiment shown in FIG. 2, the material transfer assembly 28 includes a print cylinder 50 and an impression cylinder 54 in juxtaposition, thereby forming a printing nip 56. The spacing between the print cylinder 50 and the impression cylinder 54 is chosen based on a variety of factors, including the desired substrate and substrate thickness as well as the level of contact between the print cylinder and the substrate. It will be appreciated that the print cylinder 50 may be adjustably mounted relative to the impressions cylinder 54 so the spacing of the printing nip 56 may vary from application to application. In use, a web of substrate 60 is routed through the printing nip 56, onto which material 80 is printed by the print cylinder 50 to form the printed image 82.

The print cylinder 50 is of a conventional configuration, and includes a support shaft 66 defining the central longitudinal axis of the cylinder, and an outer circumferential support surface 68 adapted to receive a flexographic printing plate 72 having, in one embodiment, elevated sections 76 that define an image to be printed (i.e., a relief printing plate). In one embodiment, the image is a circuit layout for a printed electronic device. In other embodiments, the image is a color separation for use in graphic arts or a film applicator roll for use in coatings, colorant or surface treatments. Similar to the print cylinder 50, the impression cylinder 54 is of a conventional configuration, and includes a support shaft (not shown) defining the central longitudinal axis of the cylinder, and an outer circumferential support surface 78 adapted to support the substrate 60.

The print cylinder 50 and the impression cylinder 54 are mounted for rotation via their respective support shafts on suitable bearings, and are rotationally driven by the one or more suitable motors 34 via appropriate gearing. While the material transfer assembly 28 is shown to include an impression cylinder, other substrate support structures, such as vertical or horizontal platens, may be used.

While the embodiment in FIG. 2 illustrates the printing plate 72 having a relief image, it will be appreciated that the printing plate 72 may define a recessed image or a planographic image. Additionally, the printing plate does not need to be constructed of a flexible material as is the convention with flexography. Instead, in some embodiments, a more rigid plate with raised print areas similar to letterpress, may be used. In some embodiments, it is desired to print electronic devices that include features that are spaced approximately three (3) microns apart. To achieve this accuracy in the printed features, conventional one micron diameter lasers may be used to image a photo-resistive plate material. Once completed, conventional subtractive processes could be used to chemically etch away non-image areas yielding a printing plate with relief.

Several advantages may be realized by utilizing a relief printing plate in embodiments of the present invention, as will now be described in detail. When using printing plates with raised images, these areas of relief are the only areas that receive material from the non-contact material metering devices. Thus, only these areas transfer material onto the substrate, thereby ensuring sharp and accurate features. On occasions where ink is accidentally deposited onto non-image areas, those areas would not print due to the relief of the image, thus providing a level of redundancy.

The non-contact metering device 24 of the hybrid printing system 20 is mounted in proximity to the print cylinder 50. In several embodiments, the device 24 is mounted approximately 1-4 mm from the print cylinder 50, depending on the accuracy needed in the desired application. In one embodiment, the device 24 is mounted less than 1 mm from the print cylinder 50. The non-contact material metering device 24 is suitably configured for transferring a precisely metered quantity of material 80 onto the print image defined by the print cylinder 50 upon reception of appropriate discharge signals from, for example, the print control system 44.

In several embodiments, the non-contact metering device 24 is capable of metering a quantity of material 80 of approximately 0.75 picoliters or greater. It will be appreciated that the amount is dependent on the type of features present in the electronic device. For example, if the system 20 is to render a three (3) micron wide lines spaced three (3) microns apart having a film thickness of approximately 50 nm, the device 24 would deposit sub-picoliter droplets, such as 0.75 picoliters, at high resolution. If the system 20 is to render a 30 micron or larger gate electrode or trace having a thickness of approximately 300 nm, the device 24 would deposit droplets of approximately five (5) picoliters. It will be appreciated that the system 20 may incorporate two devices 24, one depositing droplets in the sub picoliter range, and one depositing droplets in the 5-100 picoliter range.

The non-contact material metering device 24 is connected in communication with a reservoir 86 of material. The reservoir 86 may be integrated with the device 24 or is separately located in proximity to or remote from the device 24. The materials stored in the reservoir 86 may include but are not limited conductive materials, such as gold flake, silver flake, nano-silver, or nano-gold, a semiconductive material, such as polythiophene, also known as PEDOT, or other suitable copolymers of aniline and pyrrole, and an insulative material, such as polyvinyl phenol. The material may be suspended by or dissolved in any suitable solution. It will be appreciated that one or more non-contact metering devices 24 may be used with each print cylinder 50 and can be, for example, associated with discrete print cylinder regions.

It will be appreciated that the appropriate discharge signals sent by the print control system 44 may indicate that the metered quantity of material deposited onto the print cylinder 50 may differ from location to location, thus increasing the versatility of the electronic components and circuit patterns that may be produced. In one embodiment, the non-contact material metering device 24 is a digital, non-contact, piezoelectric inkjet head. Other examples of non-contact material metering devices that may be utilized in other embodiments of the present invention may include but are not limited to well known thermal or acoustic driven inkjet heads, conventional aerosol systems, or vapor deposition systems. In a vapor deposition system, a dense vapor is generated, and the exposure time to the vapor determines the quantity of material metered to the printing plate. In this embodiment, the vapor deposition system is utilized in conjunction with a relief printing plate in order to render acceptable printed electronics.

In several embodiments of the present invention, inkjet heads are used as the non-contact material metering device due to many beneficial features, some of which will now be described. Inkjet heads, such as piezo inkjet heads, can accommodate a wide range of materials and viscosities, thus lending to a more flexible printing platform. Inkjet heads are also engineered to precisely meter a specified amount of material, and are capable of precisely metering material on to the order of about 0.75 picoliters. Inkjet heads are typically configured with a plurality of discrete discharge nozzles (e.g., 1, 16, 64, 128, or 256), which can be individually discharged based on the received discharge signals. The number of nozzles and the ability to control the discharge of each nozzle provides extremely accurate and flexible placement of the material onto the image formed by the printing plate. Inkjet heads also provide many environmental and fluid handling benefits with their ability to provide a sealed reservoir. This minimizes or potentially eliminates the troubles associated with volatile organic compounds (VOC) emissions. Sealed reservoirs also reduce material waste with respect to evaporation, contamination and cleanup, and simplify the cost of operation.

It will be appreciated that the printing system 20 may contain other components not shown for ease of illustration. For example, the printing system 20 includes a frame to which the working components are functionally connected. The frame may be any variety of structural members that are assembled together to hold, support, etc. the various components and may be generally by constructed of steel frame members welded, riveted, bolted, or otherwise connected together.

In order to print an image using the printing system 20, a web of substrate 60 is advanced through the printing nip 56, and is coupled to a conventional take-up spool or other type of web advancement structure 40. When the print control system 44 is ready to print the desired image, the print control system 44 sends appropriate signals to the non-contact metering device 24, and to the one or more motors 34 for rotating the print and impression cylinders 50 and 54 and to power the web advancement structure 40 for advancing the substrate 60 through the printing nip 56. As the substrate 60 is advanced through the printing nip 56 and the print and impression cylinders 50 and 54 are rotating in the opposite direction to one another, the non-contact metering device 24, based on the signals sent by the print control system 44 to the non-contact metering device 24, deposits material 80 at the appropriate time onto the rotating printing plate 72 of the print cylinder 50 in metered quantities and selected locations, such as the elevated sections 76 that form the print image.

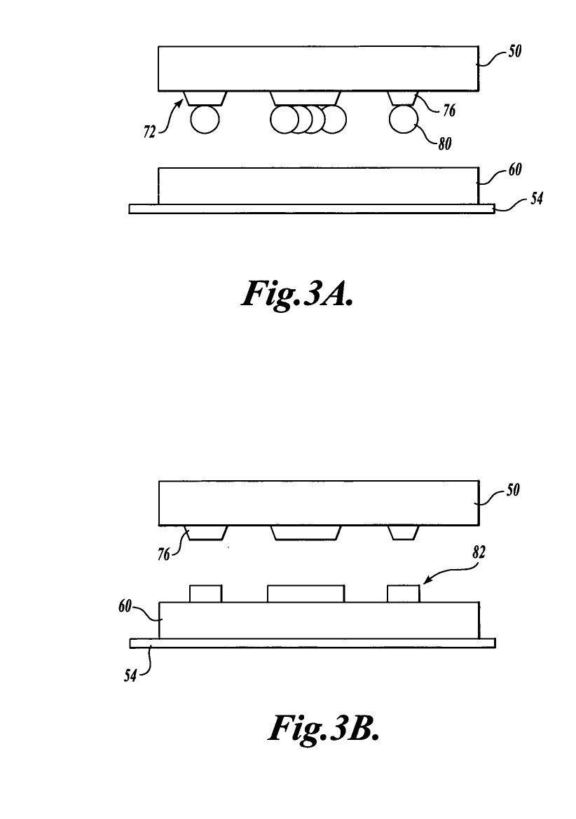

It will be appreciated that the rotation of the print cylinder 50 and the deposition of the material 80 by the non-contact metering device 24 onto the print cylinder 50 is synchronized so that the material 80 is deposited in the location and quantities desired. As the print cylinder 50 and the impression cylinder 54 rotate opposite one another, a section of the substrate 60 passes through the printing nip 56. As the section of substrate 60 travels through the printing nip 56, material 80 from the printing plate 72 is transferred by contact to the substrate 60 in the form of the printing plate image, as shown in detail in FIGS. 3A and 3B. As such, the material 80 is deposited onto the substrate 60 as a printed layer, thereby forming the printed image 82.

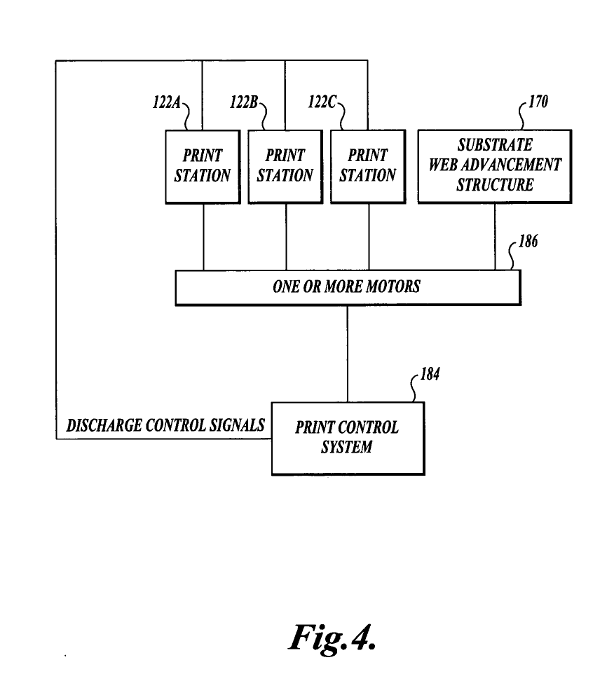

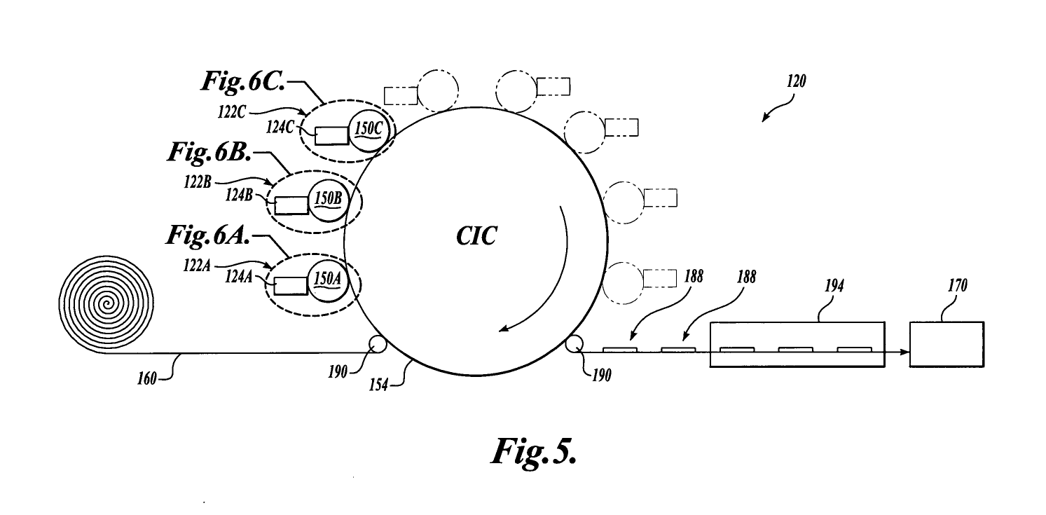

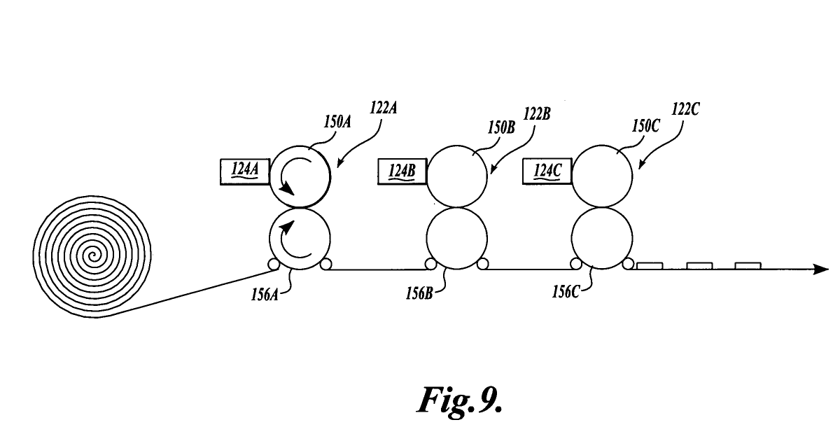

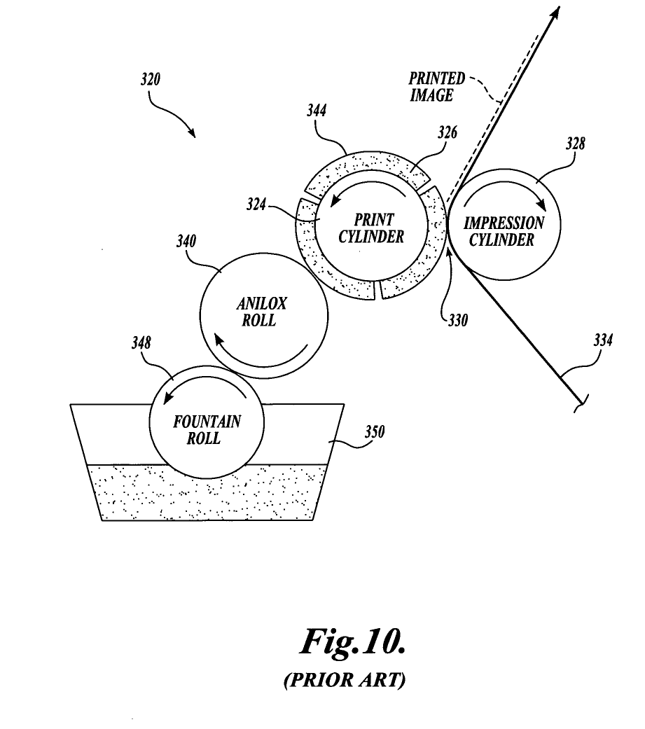

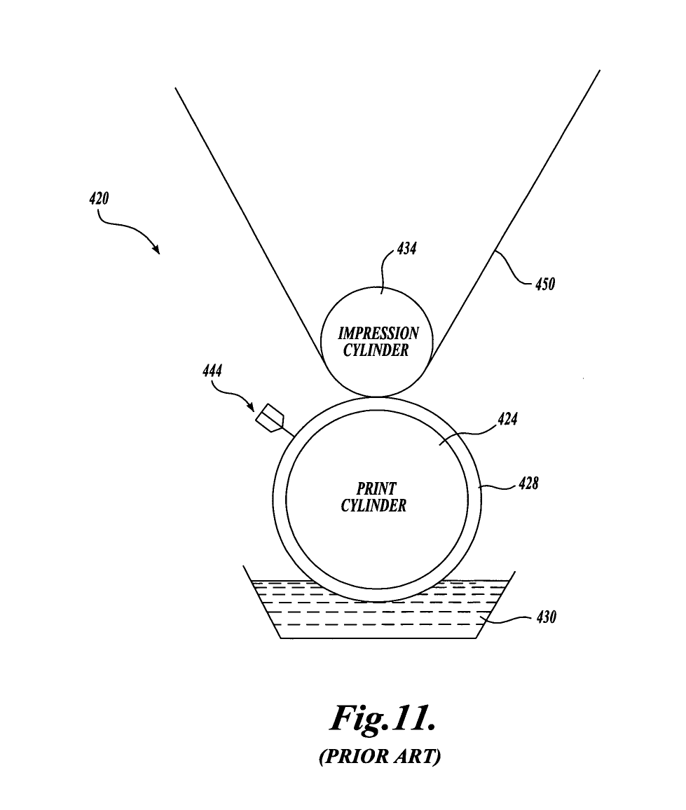

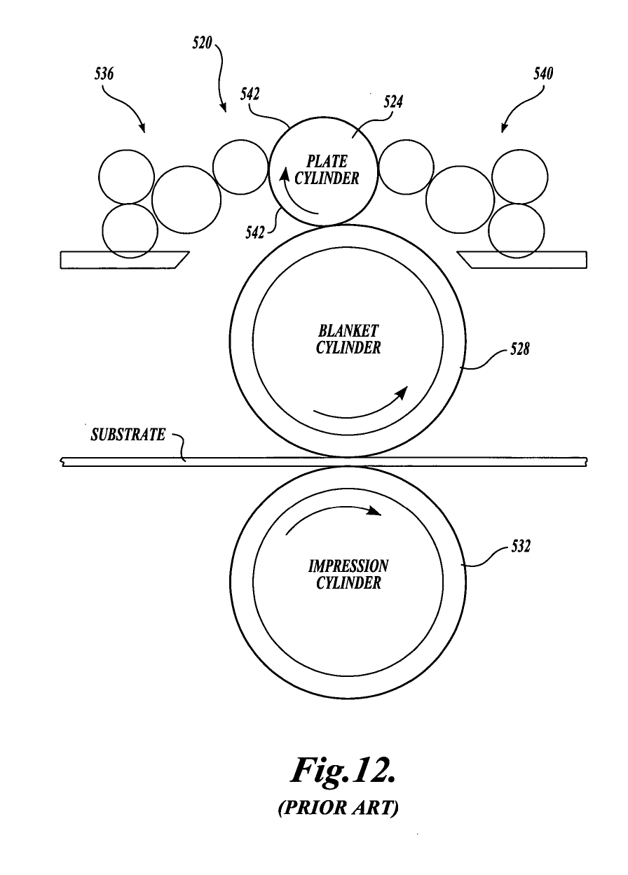

Turning now to FIG. 4, there is shown a schematic representation of another embodiment of a hybrid printing system, generally indicated as 120, formed in accordance with aspects of the present invention. The system 120 is substantially similar in materials, construction and operation of as the printing system shown in FIGS. 1-3, except for the differences that will be explained in detail below. The system 120 is suitable for fabricating selected electronic components, such as a capacitor, having multiple layers of deposited material. As shown in FIG. 5, the system 120 includes a plurality (shown as three) printing stations 122A-122C, each comprised of a non-contact metering device 124A-124C, such as an inkjet head, a print cylinder 150A-150C, and a section of a central impression cylinder (CIC) 154, respectively. While a CIC is shown, other configurations may be practiced with the present invention, such as discrete impression cylinders 156A-156C for each print cylinder 150A-150C in an in-line configuration, as best shown in FIG. 9.

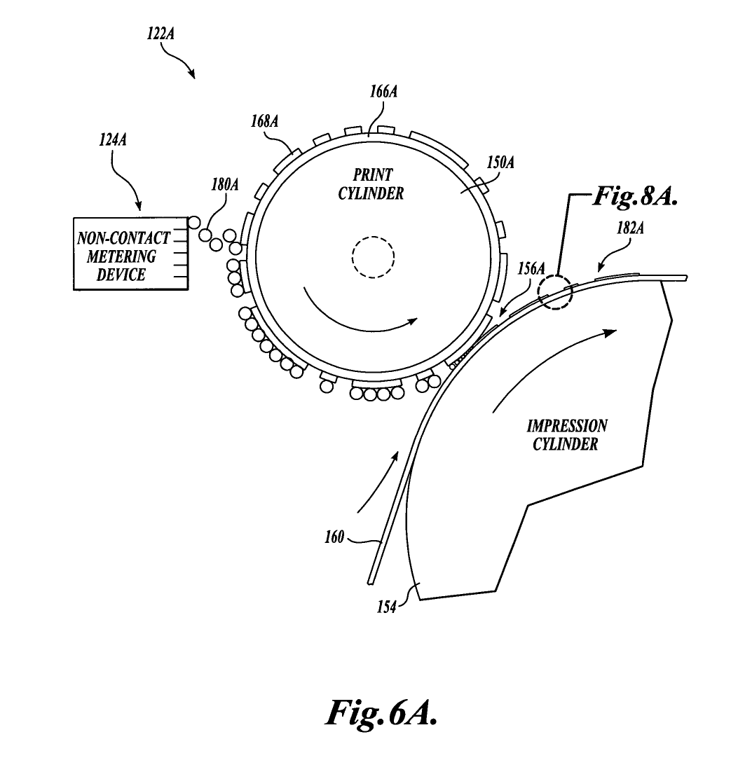

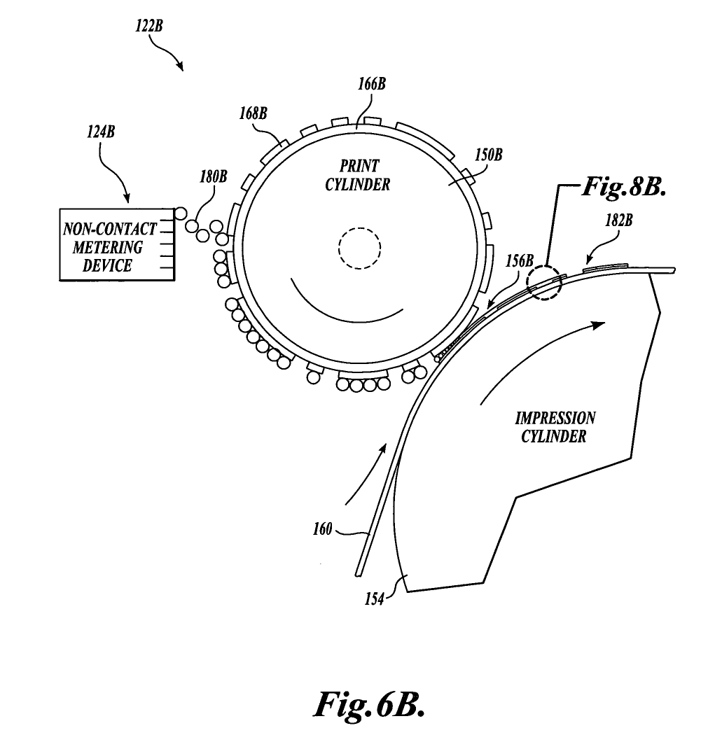

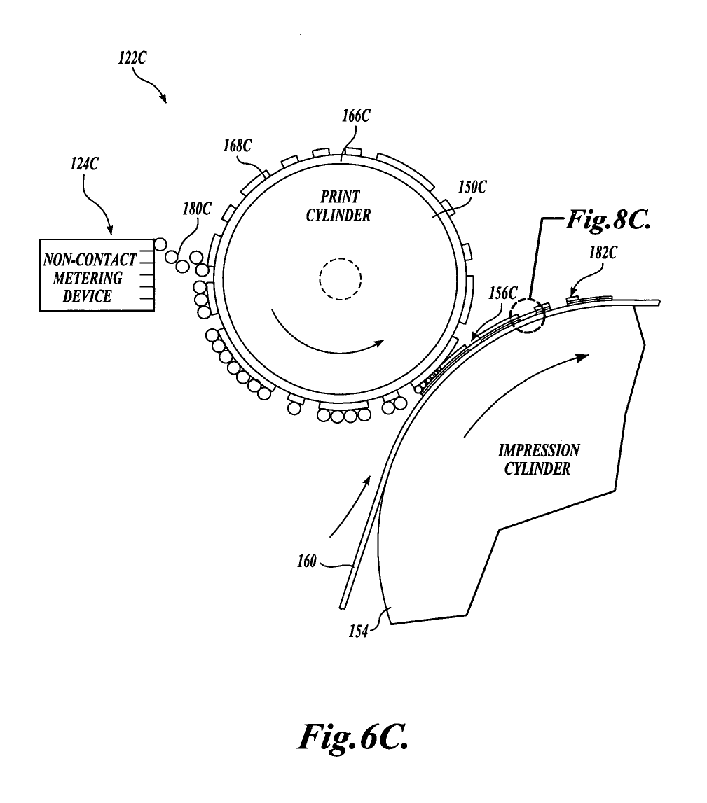

Returning to FIG. 5, the print cylinders 150A-150C are positioned symmetrically around a portion of the CIC 154, a spaced distance therefrom to form suitable printing nips 158A-158C (See FIG. 6A-6C) for receiving a selected substrate. It will be appreciated that the print cylinders 150A-150C may be adjustably mounted for adjusting the printing nips 158A-158C so as to accommodate different substrates and substrate thicknesses. In the embodiment shown, the non-contact material metering devices 124A-124C are inkjet heads, each of which is connected in fluid communication with a respective reservoir (not shown) holding one of a plurality of desired polymeric or non-polymeric materials. Such materials may include, but are not limited to conductive materials, semi-conductive materials, and dielectric materials.

In the embodiment shown, inkjet heads 124A, 124B, and 124C are connected to reservoirs holding a conductive material, such as gold, an insulative material, such as polyvinlyphenol, and another conductive material, such as silver, respectively. As such, the additive layers deposited by the printing stations 122A-122C can be used to form a capacitor, as will be described in detail below.

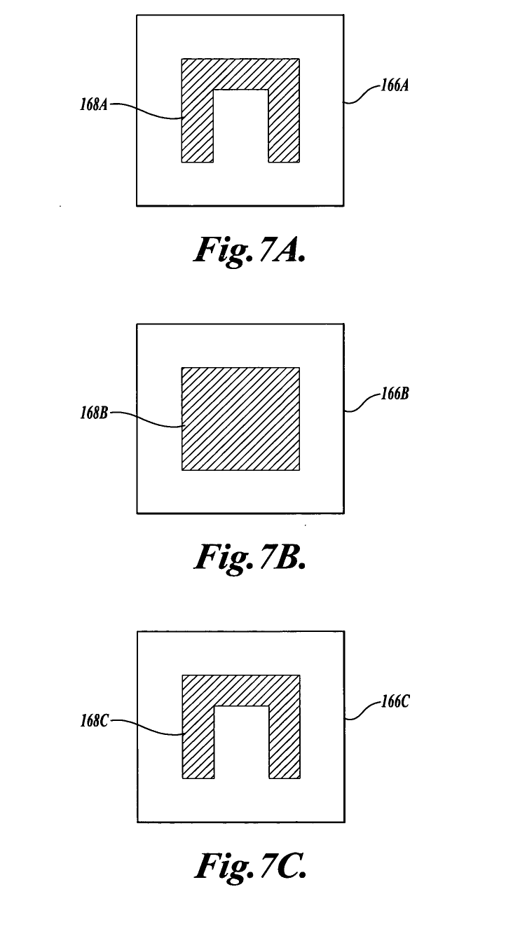

Each print cylinder 150A-150C supports a printing plate 166A-166C, respectively. As best shown in FIG. 6A-6C, each printing plate 166A-166C defines print image 168A-168C, wherein the aggregate layers of the print images form the electronic device to be printed. The print images 168A-168C may be formed either in relief, recessed, or planographic. In the embodiment shown, the print images are formed in relief. Turning to FIGS. 7A-7C, there is shown one example of a set of printing plates 166A-166C, for fabricating a capacitor with polymeric and non-polymeric materials in a fully additive process. As best shown in FIGS. 7A-7C, each printing plate 166A-166C defines the print images 168A-168C, respectively, to be printed onto the substrate 160.

One suitable method for using the system 120 for fabricating an electronic device 188 will now be described with reference to FIGS. 4-8. As best shown in FIG. 5, a web of substrate 160 is weaved around appropriate rollers 190, around the impression cylinder 154, and coupled to a take-up spool or other type of web advancement structure 170. When the print control system 184 is ready to print the desired printed electronic device, the print control system 184 sends appropriate signals to the non-contact metering device 124A, and to the one or more motors 186 for rotating the print and impression cylinders 150A-154C and 154 and to power the web advancement structure 170 for advancing the substrate 160 through the first printing nip 156A of the first printing station 122A. As the substrate 160 is advanced through the printing nip 156A and the print cylinder 150A and impression cylinder 154 are rotating in the opposite direction to one another, the non-contact metering device 124A, based on the signals sent by the print control system 184 thereto, deposits material 180A at the appropriate time onto the rotating printing plate 166A of the print cylinder 150A in metered quantities and selected locations, such as the print image 168A.

It will be appreciated that the rotation of the print cylinder 150A and the deposition of the material 180A by the non-contact metering device 124A onto the print cylinder 150A is synchronized so that the material 180A is deposited in the location and quantities desired. As the print cylinder 150A and the impression cylinder 154 rotate opposite one another, a section of the substrate 160 passes through the printing nip 156A of the first printing station 122A. As the section of substrate 160 travels through the printing nip 156A, material 180A from the printing plate 166A is transferred by contact onto the substrate 160 in the form of the print image 168A. As such, the first printing station 122A deposits a first layer of material 180A onto the substrate, thereby forming the first printed image layer 182A. In one embodiment, the first printing station 122A deposits a conductor, such as gold, onto the substrate 160 in the pattern shown in FIG. 7A, approximately 50 nanometers thick.

The section of the substrate 160 now having the first printed image layer 182A thereon is advanced to the second printing station 122B, where the steps of depositing a second layer onto the first printed image layer 182A occurs. It will again be appreciated that the second printing station 122B operates substantially similar to the first printing station 122A, such that upon proper signals from the control system 184, material 180B is deposited from the non-contact metering device 124B onto the print image 168B of the printing plate 166B, which in turn, transfers the material 180B from the printing plate 166B onto at least a portion of the first printed image layer 182A as the substrate passes through the second printing nip 156B of the second printing station 122B, thereby forming the second printed image layer 182B.

In one embodiment, the second printing station 122B deposits an insulator, such as polyvinlyphenol, as the second printing image layer 182B onto the first printed image layer 182A. The second printed image layer is in the form of the image 168B shown in FIG. 7B, and is approximately 200 nanometers thick. In this embodiment, the second printing station is capable of layer to layer (i.e., between the first and second layers 182A and 182B) registration tolerances of approximately 25 microns.

The section of the substrate 160 now having the first and second printed image layers 182A and 182B thereon is advanced to the third printing station 122C, where the steps of depositing a third layer of material 180C onto the first two printed image layers occurs. It will again be appreciated that the third printing station 182C operates substantially similar to the first and second printing stations 122A-B, such that upon proper signals from the control system 184, material 180C is deposited from the non-contact metering device 124C onto the print image 168C of the printing plate 166C, which in turn, transfers the material 180C from the printing plate 166C onto at least a portion of the first and/or second printed image layer 182A, 182B as the substrate 160 passes through the third printing nip 156C of the third printing station 122C, thereby forming the third printed image layer 182C.

In one embodiment, the third printing station 122C deposits a conductor, such as silver, onto the second printed image layer 182B in the form of the image shown in FIG. 7C, approximately 100 nanometers thick. In this embodiment, the third printing station 122C is capable of layer to layer (i.e., between the second and third layers 182B and 182C) registration tolerances of approximately 25 microns.

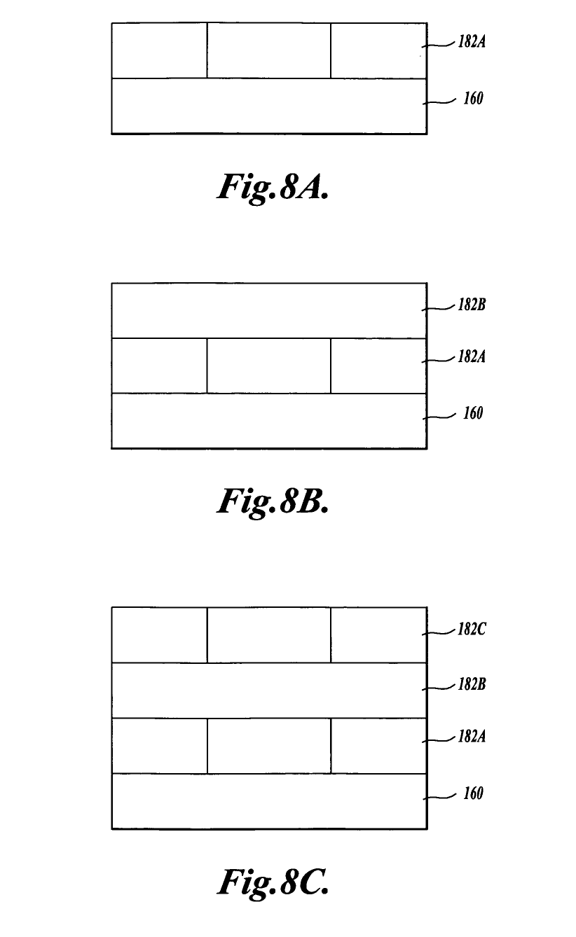

If electronic devices having more than three layers are desired to be fabricated, any number of additional printing stations 122 may be added, as shown in phantom in FIG. 5, for printing the appropriate material and the desired image onto the aggregate layers. Once the electronic device 188 is finished printing in such an additive process, the substrate 160 may be routed through a drying device 194, such as a thermal oven, operating at temperature ranges of approximately 100-180 degrees Celsius. A side view of one suitable electronic device fabricated by the printing system 120 is shown layer by layer in FIGS. 8A-8C.

As can been seen from the above description and illustrated herein, embodiments of the present invention provide hybrid printing systems and methods for fabricating electronic devices in an additive process. By using a non-contact material metering device, such as an inkjet head, precisely metered amounts of material can be deposited onto a printing plate in the desired locations. The precise metering and location depositing abilities of the inkjet heads also provide the hybrid systems and methods the ability to deposit layers of material having substantially uniform thickness on the order of 50-100 nanometers or thicker. Inkjet heads and relief printing plates also provide the ability to place features, such as traces, electrodes, etc. within three (3) microns, to produce straight and continuous lines, and to provide layer to layer registration tolerances in some instances to be below 25 microns.

While fabrication of a capacitor was illustrated and described herein, other electronic devices may be fabricated using the methods and systems described herein. For example, it will be appreciated that by the selection of the materials to be deposited, the images formed on each printing plate, the sequential order of the deposited layers, and the number of print stations, any of a number of electronic devices may be fabricated. Several examples of electronic devices include but are not limited to resistors, capacitors, inductors, transistors, diodes, rectifiers, oscillators, memory, such as chemical sensors, electrical sensors, temperature sensors, humidity sensors, pressure sensors, motion sensors, and pH sensors, displays, speakers, I/O panels, clocks, electroluminescent lamps, solar cells, infrared cells, and radios.

In one non-limiting embodiment, a transistor may be formed with a system having four printing stations that deposit sequential layers of a first conductor, such as gold, a semiconductor, such as polythiophen, also known as PEDOT, an insulator or dielectric such as polyvinyl phenol, and a second conductor, such as silver, respectively.

It will be appreciated that any material dissolved or suspended in solution, for example, conventional printing inks, conductive and semi-conductive polymeric or non-polymeric inks, dielectric polymers, micro or nano-particle metallic inks, organic and inorganic dyes and pigments, paints, barrier materials, adhesives, varnishes etc., may be practiced with the embodiments of the present invention, and discharged by the non-contact metering devices utilized in embodiments of the present invention.

In embodiments where process or non process color inks are printed in a color printing environment, many benefits over conventional printing systems may be realized. For example, the use of non-contact material metering devices, such as inkjet heads, simplify the printing system by eliminating the need for additional metering hardware, such as doctor blades, ink chambers, piping, pumps, anilox rolls, ink pick up and transfer rolls, venting hoods and fans for handling the VOCs, etc. Thus, the use of non-contact material metering devices with analog printing press components, such as print cylinders and impression cylinders, could greatly simplify the operation and cost of such equipment in the commercial print industry.

Although the present invention has been described with reference to embodiments illustrated in the attached drawings, it is noted that substitutions may be made and equivalents employed herein without departing from the scope of the invention as recited in the claims. For example, although embodiments of the present invention have been described with reference to flexography presses, it will be appreciated that aspects of the present invention can also be employed using components from other types of web printing presses, such as lithography, letterpress, rotogravure and screen printing, and components and techniques are contemplated to be within the scope of the present invention. In several embodiments, the substrate may be selected from but not limited to uncoated paper, coated paper, laminated paper products, corrugated board, dimension lumber, plywood, glass, and various plastic films, such as polyethylene or polynaphthalene, cellulosic films, etc. Further, while the print stations 122A-122C have been shown and described as being hybrid print stations, it will be appreciated that any one of them may be a conventional print station, such as an ink jet head, gravure, or flexographic. It is therefore intended that the scope of the invention be determined from the following claims and equivalents thereof.

The embodiments of the invention in which an exclusive property or privilege is claimed are defined as follows:

1. A method of printing an electronic device onto a substrate, comprising:
obtaining a substrate;
routing the substrate through a sequential series of printing nips, said nips formed between at least a portion of one substrate support structure and a plurality of plate structures, each plate structure defining a print image;
sequentially depositing one of a plurality of materials onto the print images of the plate structures, the sequential depositing of material being carried out by a plurality of non-contact metering devices, wherein the print image of each plate structure represents the final image layers to be printed on the substrate; and
sequentially transferring the material deposited on the print images of the plate structures onto the substrate layer-by-layer as the substrate is routed through the sequential series of printing nips, thereby forming, in an additive manner, a printed electronic device comprised of a plurality of printed image layers.

2. The method of claim 1, wherein at least one of the printed image layers has a substantial uniform thickness.

3. The method of claim 2, wherein the thickness of the at least one printed image layer is in the range of approximately 50-200 nanometers.

4. The method of claim 1, wherein the print image is selected from the group consisting of a recessed print image, a relief print image, and a planographic print image.

5. The method of claim 1, wherein the non-contact metering device is an inkjet head.

6. The method of claim 1, wherein the plurality of materials is selected from a group consisting of conductive materials, semiconductive materials, and insulative materials.

7. The method of claim 1, wherein the substrate is selected from the group consisting of uncoated paper, coated paper, laminated paper, corrugated board, dimension lumber, plywood, glass, plastic film, and cellulosic film.

8. The method of claim 1, wherein the substrate support structure is an impression cylinder.

9. The method of claim 1, wherein the plate structure is a plate cylinder.

10. The product formed by the process of claim 1.

11. A method of printing a plurality of print layers, comprising:
(a) routing a substrate to a first printing station, whereby the first printing station comprises a non-contact material metering device, a print cylinder defining a first print image, and at least a portion of an impression cylinder;
(b) depositing a first material onto the print image of the print cylinder by a non-contact material metering device;
(c) transferring the first material deposited on the print image onto the substrate, thereby forming a discrete first printed image layer;
(d) routing the substrate to a second printing station, whereby the second printing station comprises a second non-contact material metering device, a second print cylinder defining a second print image, and a portion of an impression cylinder;
(e) depositing a second material onto the second print image of the second print cylinder by the second non-contact material metering device; and
(f) transferring the second material from the second print image onto at least a portion of the first printed layer, thereby forming a discrete second printed image layer.

12. The method of claim 11, wherein the first or second printed image layer has a substantially uniform thickness.

13. The method of claim 11, wherein the thickness of the first or second printed image layer is in the range of approximately 50-200 nanometers.

14. The method of claim 11, wherein the first or second non-contact material metering device is an inkjet head.

15. The method of claim 11, wherein the substrate is selected from the group consisting of uncoated paper, coated paper, laminated paper, corrugated board, dimension lumber, plywood, glass, plastic film, and cellulosic film.

16. The method of claim 11, wherein the material is selected from a group consisting of conductive materials, semiconductive materials, and insulative materials, metallic inks, non-metallic inks, varnish, adhesive, polymeric coatings, organic dyes, inorganic dyes, paint, and barrier material.

17. The method of claim 11, further comprising:
(g) routing the substrate to a third printing station, whereby the third printing station comprises a third non-contact material metering device, a third print cylinder defining a third print image, and a portion of an impression cylinder;
(h) depositing a third material onto the third print image of the third print cylinder by the third non-contact material metering device; and
(i) transferring the third material from the third print image onto at least a portion of the first or second printed image layer, thereby forming a discrete third printed image layer.

18. The product formed by the process of claim 11.
